(19) United States
(12) Patent Application Publication
(10) Pub. No.: US 2019/0181678 A1
(43) Pub. Date: Jun. 13, 2019

(54) LIFE SERVICE EQUIPMENT

(71) Applicant: BEIJING APOLLO DING RONG SOLAR TECHNOLOGY CO., LTD., Beijing (CN)

(72) Inventors: Sen JIANG, Beijing (CN); Yi XU, Beijing (CN)

(21) Appl. No.: 16/157,334

(22) Filed: Oct. 11, 2018

Related U.S. Application Data
(63) Continuation of application No. PCT/CN2017/117927, filed on Dec. 22, 2017.

(30) Foreign Application Priority Data
Dec. 11, 2017 (CN) 201711311295.4

(51) Int. Cl. H02J 7/35; H02J 7/00; H02J 9/06; H05B 33/08; H05B 37/02; G08B 25/01

(52) U.S. Cl. CPC H02J 7/35; H02J 7/0068; G08B 25/016; H05B 33/0854; H05B 37/0218; H02J 9/061

(57) ABSTRACT

The present disclosure refers to a life service equipment comprising a functional cabinet and a solar battery; the functional cabinet comprises a distribution control cabinet, the distribution control cabinet comprises an energy storage unit, a distributor and a controller; the energy storage unit is electrically connected with the distributor, meanwhile the distributor is electrically connected with the municipal power, the controller is electrically connected to the energy storage unit and the distributor respectively; the energy storage unit is used to store the electric energy generated by the solar battery and to provide power for each sub-functional cabinet via the distributor; the controller is used to detect the power of the energy storage unit in real time, and to trigger the distributor to switch to municipal power to supply energy to each sub-functional cabinet in the case that the power of the energy storage unit is lower than a default value.

### CROSS-REFERENCE TO RELATED APPLICATION

This application is a Continuation Application of PCT/CN2017/117927 filed Dec. 22, 2017, which claims priority to Chinese Patent Application No. 201711311295.4 filed on Dec. 11, 2017, titled “MULTIFUNCTIONAL LIFE SERVICE STATION”, the entirety of which is incorporated herein by reference.

### TECHNICAL FIELD

The present disclosure relates to a living facility field, and in particular, to a life service equipment.

### BACKGROUND

With the development of the economic society, there have been some life service cabinets that improve the convenience of people's lives, such as self-service express cabinets, self-service vending cabinets, etc.

Self-service express cabinets, also known as smart courier cabinets, are a kind of self-service equipment set up in public place for people to deliver and pick up expresses.

Express cabinets can identify, temporarily store, monitor and manage express parcels; combined with smart terminals and Internet of Things, express cabinets have made it more convenient for logistics companies and individual users to send and receive expresses.

Self-service vending cabinets can automatically deliver goods according to the coins invested. Self-service vending cabinets can sell beverages, food, etc. It is free from time and place restrictions, and convenient for transactions. It is also called a 24-hour mini supermarket, which is greatly convenient for people's lives.

### SUMMARY

The purpose of the present disclosure is to provide a life service equipment.

Several embodiments of the present disclosure adopt the following technical solutions:

A life service equipment, wherein, the life service equipment comprises a functional cabinet and a solar battery;

The functional cabinet comprises at least one selected from groups consisting of the following sub-functional cabinets: a courier cabinet, a vending cabinet, a charging cabinet, a water-drinking cabinet, a shared goods cabinet, a juice squeezer cabinet, a ticket exchange cabinet and a wireless hotspot cabinet;

The functional cabinet comprises a distribution control cabinet, the distribution control cabinet comprises an energy storage unit, a distributor and a controller;

The solar battery is electrically connected to the energy storage unit, the energy storage unit is electrically connected with the distributor, meanwhile the distributor is electrically connected with the municipal power, the controller is electrically connected to the energy storage unit and the distributor respectively;

The energy storage unit is used to store the electric energy generated by the solar battery and to provide power for each sub-functional cabinet via the distributor;

The controller is used to detect the power of the energy storage unit in real time, and to trigger the distributor to switch to municipal power to supply energy to each sub-functional cabinet in the case that the power of the energy storage unit is lower than a default value.

In several embodiments of the present disclosure, the sub-functional cabinet comprises a smart courier cabinet, a self-service vending cabinet, and a self-service charging cabinet; each sub-functional cabinet is connected to each other as a whole structure.

In several embodiments of the present disclosure, the solar battery is laid on the outer wall of the functional cabinets.

In several embodiments of the present disclosure, the life service equipment further comprises a distress alert assembly;

the distress alert assembly comprises a processor installed in the life service equipment and electrically connected to an alarm handling platform, and an alarm trigger unit and an alerter installed on the outer wall of the life service equipment;

The processor is electrically connected to the alarm trigger unit and the alerter;

The processor is configured that after detecting that the alarm trigger unit is triggered, the processor will activate the alerter to send an alert signal and will send an alert message to the alarm handling platform.

In several embodiments of the present disclosure, the life service equipment further comprises a video surveillance device, the video surveillance device is constituted to send collected video data to the processor.

In several embodiments of the present disclosure, the life service equipment is equipped with a light strip for lighting.

In several embodiments of the present disclosure, the light strip is an LED light strip.

In several embodiments of the present disclosure, the life service equipment further comprises a light sensor connected to the controller, the light sensor is used to detect the brightness of ambient light;

The LED light strip is electrically connected to the controller;

The controller is further constituted to trigger the LED light strip to turn on or off according to a brightness signal detected by the light sensor.

In several embodiments of the present disclosure, the distributor is a contactor.

In several embodiments of the present disclosure, the life service equipment further comprises a touch display screen, and the touch display screen is used to display information of multiple life services.

In several embodiments of the present disclosure, the touch display screen is electrically connected to the controller, the touch display screen is further used to display power distribution information of the life service equipment.

In several embodiments of the present disclosure, the vending cabinet is a touch-screen self-service vending cabinet, and the touch screen of the touch-screen self-service vending cabinet is integrated with the touch display screen.

In several embodiments of the present disclosure, the video surveillance device is electrically connected with the courier cabinet, the vending cabinet and the charging cabinet, so as to constitute the video surveillance device to collect the user image of the courier cabinet, the vending cabinet and/or the charging cabinet.

In several embodiments of the present disclosure, the controller is constituted to trigger the distributor to switch to municipal power in the case that the power of the energy storage unit is lower than 15% of the full power.

In several embodiments of the present disclosure, the controller is constituted to trigger the distributor to switch to municipal power in the case that the power of the energy storage unit is lower than 25% of the full power.

In several embodiments of the present disclosure, the controller is constituted to trigger the distributor to switch to municipal power in the case that the power of the energy storage unit is lower than 20% of the full power.

### BRIEF DESCRIPTION OF THE DRAWINGS

In order to make the purpose, technical solutions and the advantage of the present disclosure clearer, the accompanying drawings will be combined to further describe the present disclosure, wherein:

FIG. 1 is the schematic diagram of the life service equipment provided by the embodiment of the present disclosure;

FIG. 2 is the schematic diagram of the electrical connection of the life service equipment provided by the embodiment of the present disclosure.

### DETAILED DESCRIPTION

Embodiments of the present disclosure will be described in detail below. Examples of the embodiments are illustrated in the accompanying drawings. The same or similar reference signs herein represent the same or similar elements or elements having the same or similar functions. The embodiments described below with reference to the accompanying drawings are merely examples used to explain the present disclosure, and should not be construed as limitations to the present disclosure.

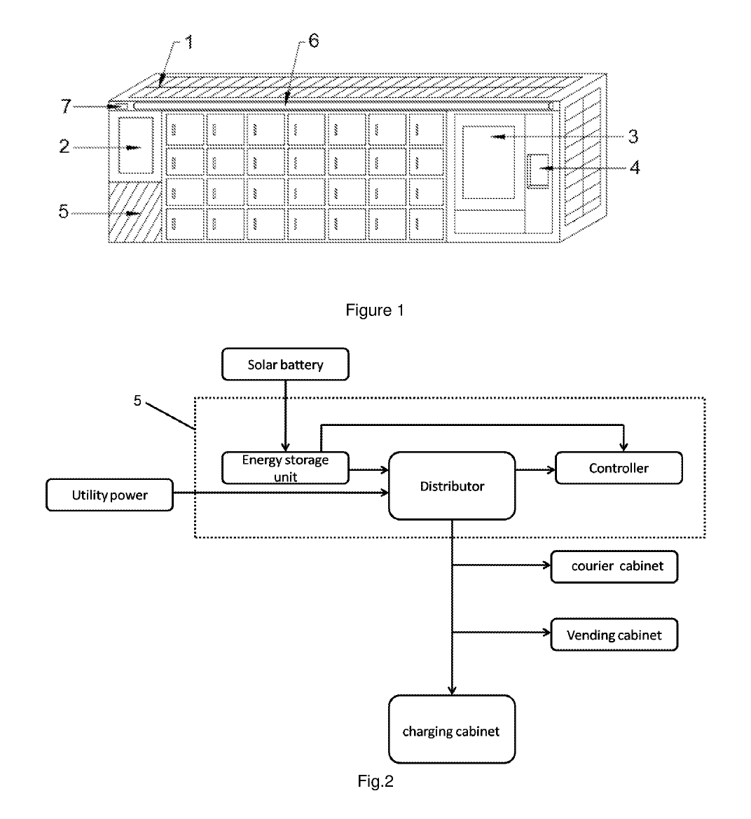

At present, life service cabinets such as courier cabinets, self-service vending cabinets all use municipal power. Once a municipal power line fails or a power outage occurs, each life service cabinet will be out of action. These situations will bring inconvenience to users and may cause a security loophole that the contents of the cabinets may be damaged or lost. In addition, each life service cabinet often has only one function and is not connected to other living facilities. For example, life service cabinets such as individual courier cabinet or self-service vending cabinet are often set up in isolation in a residential area. These facilities are not only scattered in spatial location, making it inconvenient for people to use, and (Meanwhile) each of them consume city electric resulting in a low efficiency of power and waste of resources. The present disclosure provides a life service equipment, as shown in FIG. 1, the life service equipment comprises a functional cabinet and a solar battery 1; the functional cabinet comprises at least one selected from the group consisting of the following sub-functional cabinets: a courier cabinet, a vending cabinet, a charging cabinet, a water-drinking cabinet, a shared goods cabinet, a juice squeezer cabinet, a ticket exchange cabinet and a wireless hotspot cabinet.

The functional cabinet comprises a distribution control cabinet 5. In several embodiments, the distribution control cabinet comprises an energy storage unit, a distributor and a controller. Regarding to the electrical connection of the distribution control cabinet, referred to FIG. 2, the above solar battery 1 is electrically connected to the energy storage unit, the function of the energy storage unit is to store the electric energy generated by the solar battery, and output to the aforementioned sub-functional cabinets in the normal state, therefore the energy storage unit can be a rechargeable lithium-ion battery, a conventional storage battery, etc.; in addition, the energy storage unit is electrically connected with the distributor, meanwhile the distributor is electrically connected with the municipal power, the controller is electrically connected to the energy storage unit and the distributor respectively. The controller not only uses the power of the energy storage unit, but also detects the power of the energy storage unit in real time.

When the power of the energy storage unit is low, for examples, at less than 15%, alternatively at less than 25%, alternatively at less than 20% of the full power, the controller will trigger the distributor to switch the power supply source of the sub-functional cabinets from the energy storage unit to municipal power.

As mentioned above, the present disclosure uses the environmentally friendly solar battery as a main power source, complemented by the municipal power as an auxiliary power source, and the two power supply modes are switched by the controller and the distributor, so that it can reduce the energy consumption effectively. The life service equipment uses a solar battery as the main power supply circuit and the municipal power as an auxiliary circuit. In this way, energy consumption can be effectively reduced, and there will be double reassurance in the power supply of the life service equipment.

In practical operation, a conventional programmable logic controller (PLC) with an uninterrupted power supply (UPS) can be used as a controller, and various types of distributors may also be used, such as an electronic switch, a relay, or a contactor etc. In several embodiments of the present disclosure, a contactor is used as the distributor, and the electrical connection mode may also be varied and is not limited. For example, the energy storage unit is connected to a normally closed circuit of the contactor, a municipal power line is connected to the main circuit of the contactor, and the output end of the controller is electrically connected to the coil of the contactor. The persons skilled in the art can understand that the municipal power is usually alternating current, and the power provided by the solar battery is usually direct current, and whether to choose alternating current power supply or direct current power supply depends on the specific power distribution requirements of the sub-functional cabinets. For example, if alternating current is required, an inverter can be added to change the direct current before it is output to the sub-functional cabinets; conversely, a rectifier can be added. These are general settings in the electrical field, which the present disclosure will not elaborate. It may also be added that the controller can be independent of other sub-functional cabinets, and a control module in a control system of other sub-functional cabinets may also be integrated with the controller in the power distribution control cabinet 5.

In addition, in several embodiments, the life service equipment of the present disclosure further combines function of multiple living facilities, which allows for more abundant and convenient services, demonstrating the function of providing one-stop multiple life services.

In several embodiments, ‘the sub-functional cabinets’ refers to the cabinets providing life service function except the distribution control cabinet in the functional cabinets of the life service equipment of the present disclosure.

For example, as shown in FIG. 1, the life service equipment of the present disclosure comprises a plurality of sub-functional cabinets connected to each other as a whole structure. It should be noted here that the plurality of sub-functional cabinets can be arranged in a row as shown in FIG. 1, or can be arranged into other reasonable spatial shapes according to the number and size of the functional cabinets.

The aforementioned functional cabinets may comprise a courier cabinet 2, a vending cabinet 3, a charging cabinet 4 that is used to charge the smart terminals, and a distribution control cabinet 5. If there is enough space, a water-drinking cabinet, a shared goods cabinet, a juice squeezer cabinet, a ticket exchange cabinet and a wireless hotspot cabinet may also be added. Since providing a wireless hotspot only requires a wireless router with broadband access, and does not require an extra cabinet, in some embodiment of the present disclosure, the wireless hotspot device is installed in the charging cabinet 4.

In several embodiments, the solar battery laid on the outer wall of the function cabinet. The solar battery 1 can be laid on the top of or the lateral side of the outer wall of the life service equipment, where it is more convenient to collect sunlight; in addition, the solar battery 1 may be a crystalline silicon battery, a flexible film, etc., which is not limited by the present disclosure.

In several embodiments of the present disclosure, the life service equipment further comprises a distress alert assembly. The distress alert assembly comprises a processor installed in the life service equipment and electrically connected to an alarm handling platform, and an alarm trigger unit and an alerter installed on outer wall of the life service equipment. The alarm handling platform refers to a monitoring system set up in police stations, security rooms, and community hospitals. Therefore, a wireless communication method may be adopted for the electrical connection between the processor and the alarm handling platform, and the processor may also be integrated with the controller. In addition, the processor is electrically connected to the alarm trigger unit and the alerter respectively. After detecting that the alarm trigger unit is triggered, the processor will activate the alerter to send an alert signal and will send an alert message to the alarm handling platform. The alarm trigger unit herein may be a button or a rotary switch with a call function, and the alerter may be an audible and visual alarm. In several embodiments, it may also set up a video surveillance device, such as a 360° camera or a tracking image acquisition instrument, on the life service equipment. The video surveillance device may send the collected video data to the processor, so that the processor may send the video data around the life service equipment to the alarm handling platform. Persons skilled in the art can understand that the video surveillance device can be electrically connected to the respective systems of the courier cabinet, the vending cabinet and the charging cabinet to obtain images of users using the above sub-functional cabinets, so as to facilitate the tracking and checking of the using information of the functional cabinets.

The purpose of adding a distress alert assembly to the life service equipment is to make it easier for passersby to notify the alarm handling platform at the nearest life service equipment in the case of an emergency, such as an unlawful attack or a sudden disease. Moreover, the broadcast effect of the alerter may stop the attacker from attacking or attract the attention of other persons, so that they can provide timely assistance.

Referred to FIG. 1 again, in several embodiments of the present embodiment, the life service equipment further comprises a light strip for lighting. In practical operation, a fluorescent lamp or a light emitting diode (LED) lamp may be used. For the purpose of ensuring light brightness and reducing energy consumption, a LED light strip 6 is optionally used. It should be noted that the power supply mode of the LED light strip 6 is not limited by the present disclosure. It may be powered by the energy storage unit or be directly connected to the solar battery. It may be connected to the circuit of a sub-functional cabinet and share a power source with the sub-functional cabinet. In addition, the light strip may be turned on at all times, so that it can attract users' attention at any time. Or for the sake of energy conservation, a light sensor 7 may be further provided on the outer wall of the life service equipment in order to detect the brightness of ambient light. The light sensor can convert the current photometric value into a voltage signal, and can perform better if it is installed on the upper part or top of the life service equipment. With respect to electrical connection, the light sensor 7 and the LED light strip 6 may be electrically connected to the controller respectively, so that the controller can trigger the LED light strip to turn on or off according to the brightness signal of the ambient light detected by the light sensor.

In addition, in several embodiments of the present disclosure, the life service equipment further comprises a touch display screen which displays the information of multiple life services, such as a map service, an advertisement, a notice for missing persons or lost items, and other handy services for the public. In several embodiments, the touch display screen may be electrically connected to a controller or a control system of the smart courier cabinet, so that the touch display screen may also display the operative condition of the life service equipment, such as power distribution information, the power of the energy storage unit, or information of an express items, etc.

The touch display screen may be installed on the back or lateral side of the outer wall of the life service equipment. However, if there are only a few people passing by from the back or lateral side of the outer wall of the life service equipment due to its location, it may be considered to integrate the touch display screen with the sub-functional cabinets. For example, in several embodiments of the present disclosure, the aforementioned vending cabinet is a touch-screen self-service vending cabinet; therefore, the touch display screen can be integrated with the touch screen of the touch-screen self-service vending cabinet, which is used to select merchandises. In this way, users can purchase goods, or check or inquire about life service information on one screen.

The structures, features, and effects of the present disclosure are described in detail above with reference to the embodiments shown in the drawings. However, the above embodiments are merely some preferred embodiments of the present disclosure. It should be stated that, the technical features involved in the above embodiments and their preferred modes can be reasonably combined into multiple equivalent solutions without departing from or changing the design ideas and technical effects of the present disclosure. Therefore, the present disclosure is not limited to the embodiments shown in the drawings. Any changes made according to the concept of the present disclosure or any equivalent embodiments that are modified to equivalent variations without departing from the spirit of the description and the drawings, should still fall within the protection scope of the present disclosure.

What is claimed is:

1. A life service equipment, wherein, the life service equipment comprises a functional cabinet and a solar battery;
the functional cabinet comprises at least one selected from groups consisting of the following sub-functional cabinets: a courier cabinet, a vending cabinet, a charging cabinet, a water-drinking cabinet, a shared goods cabinet, a juice squeezer cabinet, a ticket exchange cabinet and a wireless hotspot cabinet;
the functional cabinet comprises a distribution control cabinet, the distribution control cabinet comprises an energy storage unit, a distributor and a controller;
the solar battery is electrically connected to the energy storage unit, the energy storage unit is electrically connected with the distributor, meanwhile the distributor is electrically connected with the municipal power, the controller is electrically connected to the energy storage unit and the distributor respectively;
the energy storage unit is used to store the electric energy generated by the solar battery and to provide power for each sub-functional cabinet via the distributor;
the controller is used to detect the power of the energy storage unit in real time, and to trigger the distributor to switch to municipal power to supply energy to each sub-functional cabinet in the case that the power of the energy storage unit is lower than a default value.

2. The life service equipment according to claim 1, wherein, the sub-functional cabinet comprises a smart courier cabinet, a self-service vending cabinet, and a self-service charging cabinet; each sub-functional cabinet is connected to each other as a whole structure.

3. The life service equipment according to claim 2, wherein, the solar battery is laid on the outer wall of the functional cabinets.

4. The life service equipment according to claim 3, wherein, the life service equipment comprises a distress alert assembly;
the distress alert assembly comprises a processor installed in the life service equipment and electrically connected to an alarm handling platform, and an alarm trigger unit and an alerter installed on the outer wall of the life service equipment;
the processor is electrically connected to the alarm trigger unit and the alerter;
the processor is configured that after detecting that the alarm trigger unit is triggered, the processor will activate the alerter to send an alert signal and will send an alert message to the alarm handling platform.

5. The life service equipment according to claim 4, wherein, the distress alert assembly comprises a video surveillance device, the video surveillance device is constituted to send collected video data to the processor.

6. The life service equipment according to claim 3, wherein, the life service equipment is equipped with a light strip for lighting.

7. The life service equipment according to claim 6, wherein, the light strip is an LED light strip.

8. The life service equipment according to claim 7, wherein, life service equipment further comprises a light sensor connected to the controller, the light sensor is used to detect the brightness of ambient light;
the LED light strip is electrically connected to the controller;
the controller is further constituted to trigger the LED light strip to turn on or off according to a brightness signal detected by the light sensor.

9. The life service equipment according to claim 3, wherein, the distributor is a contactor.

10. The life service equipment according to claim 3, wherein, the life service equipment comprises a touch display screen, and the touch display screen is used to display information of multiple life services.

11. The life service equipment according to claim 10, wherein, the touch display screen is electrically connected to the controller, the touch display screen is further used to display power distribution information of the life service equipment.

12. The life service equipment according to claim 10, wherein, the vending cabinet is a touch-screen self-service vending cabinet, and the touch screen of the touch-screen self-service vending cabinet is integrated with the touch display screen.

13. The life service equipment according to claim 5, wherein, the video surveillance device is electrically connected with the courier cabinet, the vending cabinet and the charging cabinet, so as to constitute the video surveillance device to collect the user image of the courier cabinet, the vending cabinet and/or the charging cabinet.

14. The life service equipment according to claim 3, wherein, the controller is constituted to trigger the distributor to switch to municipal power in the case that the power of the energy storage unit is lower than 15% of the full power.

15. The life service equipment according to claim 3, wherein, the controller is constituted to trigger the distributor to switch to municipal power in the case that the power of the energy storage unit is lower than 25% of the full power.

16. The life service equipment according to claim 3, wherein, the controller is constituted to trigger the distributor to switch to the municipal power in the case that the power of the energy storage unit is lower than 20% of the full power.
